(19) United States
(12) Patent Application Publication
(10) Pub. No.: US 2017/0366849 A1
(43) Pub. Date: Dec. 21, 2017

(54) METHOD AND SYSTM FOR SCHEDULING VIEWER BETWEEN CHANNELS, AND SERVER

(71) Applicant: GuangZhou Huaduo Network Technology Co., Ltd., Guangdong (CN)

(72) Inventors: Bao Xiong, Guangdong (CN); Tielei Peng, Guangdong (CN)

(21) Appl. No.: 15/522,343

(22) PCT Filed: Dec. 31, 2014
(86) PCT No.: PCT/CN2014/095874

§ 371 Date: Apr. 27, 2017

(30) Foreign Application Priority Data
Oct. 31, 2014 (CN) 201410603676.X

(51) Int. Cl. H04N 21/458; H04N 21/254; H04N 21/258; H04N 21/84

(52) U.S. Cl. CPC H04N 21/458; H04N 21/84; H04N 21/2541; H04N 21/25875; H04N 21/25891

(57) ABSTRACT

A method and a system for scheduling viewers between channels, and a server are provided. The method includes: receiving a scheduling request message, where the scheduling request message includes a requester viewer identifier, a source channel identifier, and a destination channel identifier; authenticating whether a requester viewer corresponding to the requester viewer identifier has the right to initiate a scheduling request; if it is authenticated that the requester viewer has the right to initiate the scheduling request, acquiring current viewer information in a source channel corresponding to the source channel identifier; removing the current viewer information in the source channel from a viewer list of the source channel, and adding the current viewer information in the source channel to a viewer list of a destination channel corresponding to the destination channel identifier; and delivering content of the destination channel to viewers in the viewer list of the destination channel.

This application claims priority to Chinese Patent Application No. 201410603676.X, filed with the Chinese Patent Office on Oct. 31, 2014 and entitled “METHOD AND SYSTEM FOR SCHEDULING VIEWERS BETWEEN CHANNELS IN REAL TIME”, which is incorporated herein by reference in its entirety.

### FIELD OF THE INVENTION

The present invention relates to the technical field of instant messaging, and in particular, to a method, a system, and an apparatus for scheduling viewers between channels in real time.

### BACKGROUND OF THE INVENTION

As Internet technologies rapidly develop, Internet instant messaging products are widely used. Group interactive platforms such as online game platforms, online real-time audio and video show platforms, or online chat rooms are deeply favored by extensive network viewers. The group platforms are commonly characterized in that many people gather and form an “organization” to do some interactive activities, and these “organizations” may include all viewers in a certain Internet channel. When a show on a certain channel ends, while a show on another channel is about to begin or is being given, how to quickly schedule, in real time, viewers from the channel on which the show ends to another channel is a problem to be solved, so that the viewers can continue to watch the show.

In an existing solution, an administrator publishes, by using a notice, a number of a channel on which a show is being given on a public screen of a channel on which a current show ends, so that viewers in the channel on which the show ends click the number of the channel on which the show is being given and schedule themselves to a destination channel corresponding to the number of the channel on which the show is being given. In this way, the viewers can watch the show on the destination channel.

In the foregoing solution, because the viewers in the channel on which the show ends all individually schedule themselves to the destination channel, an efficiency of scheduling to the destination channel is low, and the channel administrator is unable to ensure that all the viewers in the channel on which the show ends can actively enter the destination channel.

### SUMMARY OF THE INVENTION

In order to enhance an efficiency of scheduling viewers in a source channel to a destination channel and ensure that all the viewers in the source channel enter the destination channel, the present invention provides a method and a system for scheduling viewers between channels in real time, and a server, which efficiently solve the problem of low efficiency in the prior art.

The present invention provides a method for scheduling viewers between channels in real time, which includes:

receiving a scheduling request message, where the scheduling request message includes a requester viewer identifier, a source channel identifier, and a destination channel identifier;

authenticating whether a requester viewer corresponding to the requester viewer identifier has the right to initiate a scheduling request;

acquiring current viewer information in a source channel corresponding to the source channel identifier when it is authenticated that the requester viewer has the right to initiate the scheduling request;

removing the current viewer information in the source channel from a viewer list of the source channel, and adding the current viewer information in the source channel to a viewer list of a destination channel corresponding to the destination channel identifier; and

delivering content of the destination channel to viewers in the viewer list of the destination channel.

Preferably, the acquired current viewer information in the source channel corresponding to the source channel identifier includes, but is not limited to, a viewer identifier, a viewer name, a profile picture, and a member rank.

The method further includes:

updating, according to the viewer list of the destination channel, a viewer list displayed in channel interfaces respectively in a viewer end of each viewer in the destination channel, an administrator end and an broadcaster end that correspond to the destination channel.

The present invention provides a method for scheduling viewers between channels in real time, which includes:

receiving a scheduling request message, where the scheduling request message includes a requester viewer identifier and a source channel identifier;

authenticating whether a requester viewer corresponding to the requester viewer identifier has the right to initiate a scheduling request;

acquiring a channel in which the requester viewer corresponding to the requester viewer identifier is currently located, and using the channel as a destination channel when it is authenticated that the requester viewer has the right to initiate the scheduling request;

acquiring current viewer information in a source channel corresponding to the source channel identifier; and

delivering content of the destination channel to viewers in the source channel according to the current viewer information in the source channel.

The present invention provides a system for scheduling viewers between channels in real time, which includes:

a receiving module, configured to receive a scheduling request message initiated by a scheduling request initiation end, where the scheduling request message includes a requester viewer identifier, a source channel identifier, and a destination channel identifier;

an authentication module, configured to authenticate whether a requester viewer corresponding to the requester viewer identifier has the right to initiate a scheduling request;

an acquiring module, configured to acquire, current viewer information in a source channel corresponding to the source channel identifier and content of a destination channel corresponding to the destination channel identifier when it is authenticated that the requester viewer has the right to initiate the scheduling request; and

a delivering module, configured to remove the current viewer information in the source channel from a viewer list of the source channel, and add the current viewer information in the source channel to a viewer list of the destination channel corresponding to the destination channel identifier; and deliver the content of the destination channel to viewers in the viewer list of the destination channel.

The present invention provides a system for scheduling viewers between channels in real time, which includes:

a receiving module, configured to receive a scheduling request message, where the scheduling request message includes a requester viewer identifier and a source channel identifier;

an authentication module, configured to authenticate whether a requester viewer corresponding to the requester viewer identifier has the right to initiate a scheduling request;

an acquiring module, configured to acquire, current viewer information in a source channel corresponding to the source channel identifier and content of a channel in which the requester viewer is currently located when it is authenticated that the requester viewer has the right to initiate the scheduling request; and

a delivering module, configured to deliver, according to the current viewer information in the source channel, the content of the channel in which the requester viewer is located, to viewers in the source channel.

The present invention further provides an online multimedia live-streaming platform, which includes:

several viewer ends and scheduling request initiation ends, a database, and a multimedia server; and

a central processing server, where the central processing server includes a system for scheduling viewers between channels in real time as described above.

The present invention further provides a server, where the server includes a receiver, a processor, and a transmitter, where

the receiver is configured to receive a scheduling request message, where the scheduling request message includes a requester viewer identifier, a source channel identifier, and a destination channel identifier;

the processor is configured to authenticate whether a requester viewer corresponding to the requester viewer identifier has the right to initiate a scheduling request; acquire, if it is authenticated that the requester viewer has the right to initiate the scheduling request, current viewer information in a source channel corresponding to the source channel identifier; remove the current viewer information in the source channel from a viewer list of the source channel, and add the current viewer information in the source channel to a viewer list of a destination channel corresponding to the destination channel identifier; and

the transmitter is configured to deliver content of the destination channel to viewers in the viewer list of the destination channel.

The present invention further provides a server, where the server includes a receiver, a processor, and a transmitter, where

the receiver is configured to receive a scheduling request message, where the scheduling request message includes a requester viewer identifier and a source channel identifier;

the processor is configured to authenticate whether a requester viewer corresponding to the requester viewer identifier has the right to initiate a scheduling request; acquire, if it is authenticated that the requester viewer has the right to initiate the scheduling request, a channel in which the requester viewer is currently located and use the channel as a destination channel; and acquire current viewer information in a source channel corresponding to the source channel identifier; and

the transmitter is configured to deliver content of the destination channel to viewers in the source channel according to the current viewer information in the source channel.

In the technical solutions of the present invention, information about all viewers in a source channel is automatically acquired, and all the viewers are scheduled from the source channel to a destination channel, thereby achieving real-time scheduling of viewers between channels. Such a manner avoids complicated steps of initiating requests/invitations one by one, then approving one by one, and scheduling one by one in the prior art, and can rapidly achieve scheduling of a large number of group viewers in a channel and greatly improve work efficiency of scheduling group viewers.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a system block diagram of an application scenario of the present invention;

FIG. 2 is a flowchart of Embodiment 1 of the present invention;

FIG. 3 is a schematic diagram of a reference interface of Embodiment 1 of the present invention;

FIG. 4 is a flowchart of Embodiment 2 of the present invention;

FIG. 5 is a schematic diagram of a reference interface of Embodiment 2 of the present invention;

FIG. 6 is a time sequence diagram of Embodiment 3 of the present invention;

FIG. 7 is a block diagram of a platform system of Embodiments 1 and 2 of the present invention;

FIG. 8 is a block diagram of a system for scheduling viewers between channels in real time in Embodiments 4 and 5 of the present invention; and

FIG. 9 is a block diagram of a server of Embodiments 6 and 7 of the present invention.

### DETAILED DESCRIPTION OF THE EMBODIMENTS

The technical solutions of the embodiments of the present invention are clearly and completely described below with reference to the accompanying drawings of the embodiments of the present invention. Apparently, the described embodiments are some rather than all of the embodiments of the present invention. Based on the embodiments of the present invention, other embodiments acquired by persons of ordinary skill in the art without creative effort all belong to a protection scope of the present invention.

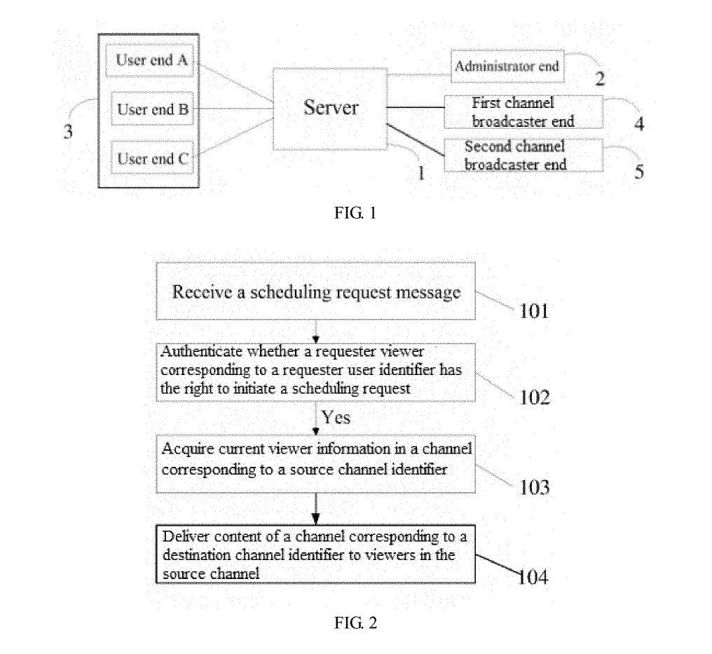

Referring to FIG. 1, FIG. 1 is a system architecture diagram of a current online multimedia show channel.

As shown in the figure, a channel viewer group 3 includes several common viewer ends A, B, C, and so on. These common viewer ends, an administrator end 2, and channel broadcaster ends 4 and 5 are all connected to a server 1 via Internet by using a specific software application program, so as to implement online multimedia communications. A common viewer initiates a communication request to a server by using a software client, where the communication request carries viewer information of the common viewer and channel information of a channel which the ordinary viewer requests to join; and the server adds the common viewer to the channel according to the viewer information of the common viewer, where the viewer information may be personal information of the common viewer. A broadcaster uploads multimedia content to a corresponding channel in the server by using a software client, and the server delivers and transmits the multimedia content of the channel corresponding to the broadcaster to the ordinary viewer who requests to enter the channel.

The administrator end 2 has the right to manage a first channel and a second channel; and may be a channel creator or may also be a specific person granted by a channel owner. It is assumed that viewers of the channel viewer group 3 currently all watch a show, given by a broadcaster corresponding to a first channel broadcaster end 4, on the first channel. When the broadcaster corresponding to the first channel broadcaster end 4 is about to complete the show, an administrator corresponding to the administrator end 2 may initiate a scheduling request to the server, so as to request to schedule all the viewers of the channel viewer group 3 to the second channel, so that the viewers can watch a show which is about to begin and given by a broadcaster corresponding to the second channel broadcaster end 5.

### Embodiment 1

This embodiment of the present invention provides a method for scheduling viewers between channels in real time, where the method can implement scheduling of viewers from a certain channel to another channel in batch. Referring to FIG. 2, the method includes the following steps:

Step 101: A server receives a scheduling request message, where the scheduling request message includes a requester viewer identifier, a source channel identifier, and a destination channel identifier.

The scheduling request message is used to enable a requester viewer to request the server to schedule a viewer from a source channel to a destination channel. The requester viewer is usually a channel administrator or a channel owner. The requester viewer has the right to request the server to schedule the viewer from the source channel to the destination channel only when the requester viewer is an administrator or a creator of both the source channel and the destination channel, where the source channel and the destination channel may be two sub-channels belonging to the same parent channel or separately located in different parent channels.

The requester viewer may select the source channel and the destination channel at a scheduling request initiation end. The scheduling request initiation end acquires the source channel identifier, the destination channel identifier, and the requester viewer identifier after detecting that the requester viewer selects the source channel and the destination channel; and sends the scheduling request message which includes the acquired source channel identifier, destination channel identifier, and requester viewer identifier to the server.

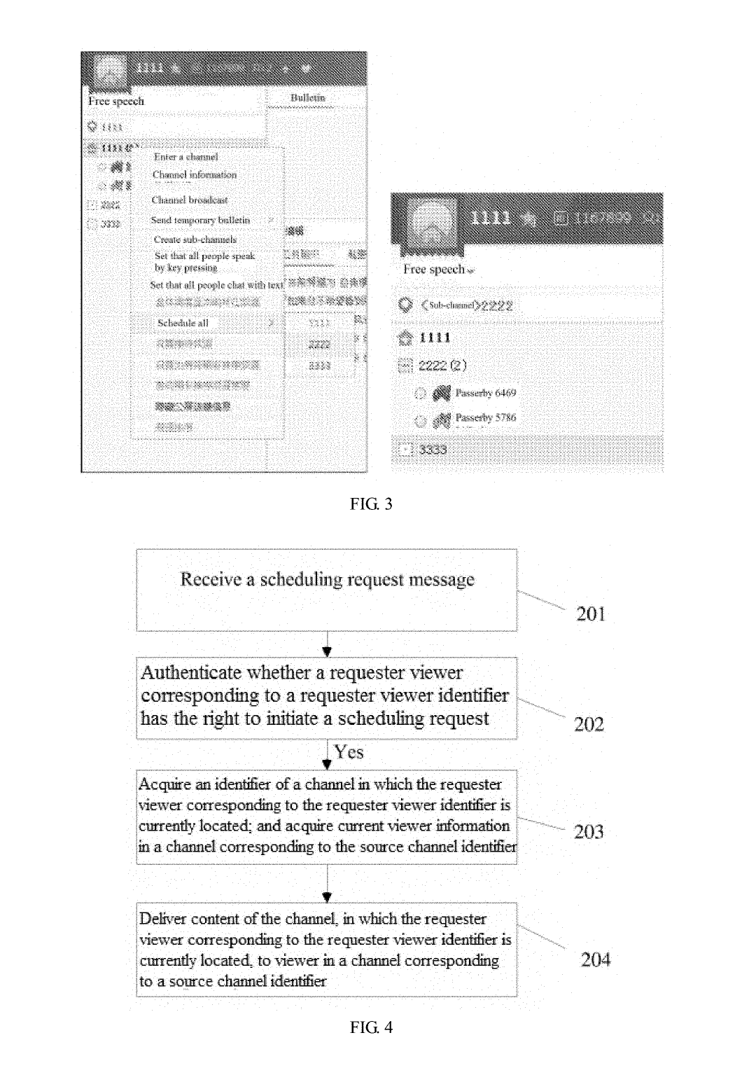

For example, referring to FIG. 3, FIG. 3 is a channel interface displayed on the scheduling request initiation end. The channel interface includes channels 1111, 2222, and 3333, and the requester viewer may select the channel 1111 as a source channel by using an input device such as a mouse. The scheduling request initiation end opens a menu of the channel 1111 after detecting that the requester viewer selects the source channel 1111, and the requester viewer selects a menu item “Schedule all” in the menu. The scheduling request initiation end displays sub-menus of the menu item after detecting that the requester viewer selects this menu item, where the sub-menus include the channels 1111, 2222, and 3333, wherein the channels 2222 and 3333 are in a selectable status, and the channel 1111 is in a non-selectable status. The requester viewer may select one channel from the selectable channels as a destination channel, and it is assumed that the channel 2222 is selected as the destination channel. A client acquires, when detecting that the requester viewer selects the destination channel 2222, a source channel identifier ID11 of the source channel 1111, a destination channel identifier ID22 of the destination channel 2222, and a requester viewer identifier uid, and sends a scheduling request message which includes the source channel identifier ID11, the destination channel identifier ID22, and the requester viewer identifier uid to the server.

Step 102: The server authenticates whether a requester viewer corresponding to the requester viewer identifier has the right to initiate a scheduling request.

Specifically, the server determines, according to the requester viewer identifier uid, whether the requester viewer is an administrator or a creator of both the source channel and the destination channel; if yes, it is authenticated that the requester viewer has the right to initiate the scheduling request; or otherwise, it is authenticated that the requester viewer has no right to initiate the scheduling request.

Before execution of this step, the server stores an administrator information list and a creator information list for each channel, where the administrator information list is used to store a correspondence between an administrator identifier and one or more channel identifier, and the creator information list is used to store a correspondence between a creator identifier and one or more channel identifier.

Therefore, a process in which the server determines, according to the requester viewer identifier uid, whether the requester viewer is an administrator or a creator of the source channel and the destination channel may be as follows.

The server acquires, according to the source channel identifier and the destination channel identifier, from the administrator information list an administrator identifier corresponding to the source channel and an administrator identifier corresponding to the destination channel; acquires, from the creator information list, a creator identifier corresponding to the source channel and a creator identifier corresponding to the destination channel; and if the requester viewer identifier uid matches both the administrator identifier corresponding to the source channel and the administrator identifier corresponding to the destination channel, or if the requester viewer identifier uid matches both the creator identifier corresponding to the source channel and the creator identifier corresponding to the destination channel, determines that the requester viewer corresponding to the requester viewer identifier uid is the administrator or the creator of both the source channel and the destination channel.

Step 103: The server acquires, current viewer information in a source channel corresponding to the source channel identifier when it is authenticated that the requester viewer has the right to initiate the scheduling request.

When the server authenticates that the requester viewer has the right to initiate the scheduling request, that is, the requester viewer is the administrator or the creator of both the source channel and the destination channel, it indicates that the requester viewer has the right to schedule viewers from the source channel to the destination channel; and then the server acquires the current viewer information in the source channel corresponding to the source channel identifier.

In the server, each channel has a viewer list, and the viewer list of the channel includes viewer information for all of the viewers who are currently online in the channel. The server usually stores a correspondence between a channel identifier of each channel and the viewer list; and updates, in real time, online viewer information in a channel corresponding to each channel identifier and the viewer list of each channel, where the viewer information includes a viewer identifier uid, a viewer name, a profile picture, a member rank, and the like.

The server may acquire, in the following manner, the current viewer information in the source channel corresponding to the source channel identifier. The server acquires, according to the source channel identifier, a viewer list of the source channel from the correspondence between the channel identifier and the viewer list, and acquires the current viewer information in the source channel from the viewer list of the source channel.

For example, if the server authenticates that the requester viewer corresponding to the requester viewer identifier uid has the right to initiate the scheduling request, the server acquires a viewer list of the source channel 1111 according to the source channel identifier ID11 from the correspondence between the channel identifier and the viewer list. It is assumed that the viewer list includes viewer information of a viewer 1 and viewer information of a viewer 2, and then the current viewer information, acquired from the viewer list of the source channel 1111 includes the viewer information of the viewer 1 and the viewer information of the viewer 2.

Step 104: The server stops, according to the acquired current viewer information in the source channel, delivering content of the source channel to a current viewer in the source channel, and delivers content of a destination channel corresponding to the destination channel identifier to the current viewer in the source channel.

The content of the destination channel is uploaded by a broadcaster corresponding to the destination channel and received by the server.

Further, the server removes the current viewer information (including an identifier, a name, a profile picture, and a member rank) in the source channel from the viewer list of the source channel, and stores the current viewer information from the source channel into a viewer list of the destination channel; and updates, according to the viewer list of the destination channel, a viewer list displayed in channel interfaces respectively in a viewer end corresponding to each viewer in the destination channel, an administrator end and a channel broadcaster end that correspond to the destination channel.

For example, the server stops, according to the viewer information of the viewer 1 and the viewer information of the viewer 2 in the source channel, delivering content of the source channel 1111 to the viewer 1 and the viewer 2 in the source channel 1111; instead, delivers content of the destination channel 2222 corresponding to the destination channel identifier ID22 to the viewer 1 and the viewer 2 in the source channel 1111. Further, the server removes the viewer information of the viewer 1 and the viewer information of the viewer 2 in the source channel 1111 from the viewer list of the source channel 1111; stores the viewer information of the viewer 1 and the viewer information of the viewer 2 from the source channel 1111 into a viewer list of the destination channel 2222; and updates, according to the viewer list of the destination channel 2222, a viewer list displayed in channel interfaces of, a viewer end corresponding to each viewer in the destination channel 2222, an administrator end and a channel broadcaster end that correspond to the destination channel 2222.

FIG. 3 is a reference diagram of an interface displayed when an administrator end performs a scheduling request in Embodiment 1.

It can be seen from FIG. 3 that, an administrator wants to schedule viewers from a current sub-channel “1111” to another sub-channel; when the administrator clicks the current channel with the right key, the administrator selects “Schedule all” and selects a scheduling destination channel, for example, selects a sub-channel “2222”. Then, after authentication performed by the server succeeds, all the viewers are scheduled from the sub-channel “1111” to the sub-channel “2222”. As shown in a screenshot in a right-side interface of FIG. 3, names and identifiers of all the viewers are switched from the sub-channel “1111” to the sub-channel “2222” and are displayed in the sub-channel “2222”. At this time, a channel interface for all the viewers subjected to schedule is switched and displays content of the sub-channel “2222”.

In the technical solutions of this embodiment, information about all viewers in a source channel is automatically acquired, and all the viewers are scheduled from the source channel to a destination channel, thereby achieving real-time scheduling of viewers between channels. Such a manner avoids complicated steps of initiating requests/invitations one by one, then approving one by one, and scheduling one by one in the prior art, and can rapidly achieve scheduling of a large number of group viewers in a channel and greatly improve work efficiency of scheduling group viewers.

### Embodiment 2

This embodiment of the present invention provides a method for scheduling viewers between channels in real time. The method may be executed by a server, and can implement real-time scheduling of viewers from a certain channel to a channel in which a requester viewer is currently located. FIG. 4 is a schematic flowchart of a method of this embodiment, and the method of this embodiment in FIG. 4 includes the following steps.

Step 201: Receive a scheduling request message, where the scheduling request message includes a requester viewer identifier and a source channel identifier.

The scheduling request message is used to enable a requester viewer to request a server to schedule viewers from a source channel to a channel in which the requester viewer is currently located, where the requester viewer is a channel administrator or a channel owner of the channel in which the requester viewer is currently located.

The requester viewer may select the source channel on a scheduling request initiation end; the scheduling request initiation end acquires the source channel identifier and the requester viewer identifier after detecting that the requester viewer selects the source channel, and sends the scheduling request message including the source channel identifier and the requester viewer identifier to the server.

For example, referring to FIG. 5, FIG. 5 shows a channel interface displayed on the scheduling request initiation end, where the channel interface includes channels “Girl's apartment” and “IM mobile phone technology seminar”, and the requester viewer is currently located in the channel “Girl's apartment”. The requester viewer may select the channel “IM mobile phone technology seminar” as a source channel by using an input device such as a mouse. The scheduling request initiation end opens a menu of the source channel “IM mobile phone technology seminar” after detecting that the requester viewer selects the source channel “IM mobile phone technology seminar”, and the requester viewer selects a menu item “Schedule to my channel in batch” in this menu. The scheduling request initiation end acquires a source channel identifier ID1 of the source channel “IM mobile phone technology seminar” and a requester viewer identifier uid after detecting that the requester viewer selects the menu item “Schedule to my channel in batch”, and sends a scheduling request message including the source channel identifier ID1 and the requester viewer identifier uid to the server.

Step 202: Authenticate whether a requester viewer corresponding to the requester viewer identifier has the right to initiate a scheduling request.

Specifically, the server determines, according to the requester viewer identifier uid, whether the requester viewer is an administrator or a creator of the source channel; if yes, authenticates that the requester viewer corresponding to the requester viewer identifier has the right to initiate the scheduling request; or otherwise, authenticates that the requester viewer corresponding to the requester viewer identifier has no right to initiate the scheduling request.

Before execution of this step, the server stores an administrator information list and a creator information list for each channel, where the administrator information list is used to store a correspondence between an administrator identifier and one or more channel identifier, and the creator information list is used to store a correspondence between a creator identifier and one or more channel identifier.

Therefore, a process in which the server determines, according to the requester viewer identifier uid, whether the requester viewer is an administrator or a creator of the source channel and a destination channel may be as follows.

The server acquires, according to the source channel identifier, an administrator identifier corresponding to the source channel from the administrator information list; acquires a creator identifier corresponding to the source channel from the creator information list; and when the requester viewer identifier uid matches the administrator identifier or the creator identifier corresponding to the source channel, determines that the requester viewer corresponding to the requester viewer identifier uid is an administrator or a creator of the source channel.

Step 203: If it is authenticated that the requester viewer has the right to initiate the scheduling request, acquire a channel in which the requester viewer is currently located and use it as a destination channel; and acquire current viewer information in a source channel corresponding to the source channel identifier.

In the server, each channel has a viewer list, and the viewer list of the channel includes viewer information of the viewers who are currently online in the channel. The server stores a correspondence between a channel identifier of each channel and the viewer list, and updates, in real time, online viewer information in a channel corresponding to each channel identifier and the viewer list of each channel, where the viewer information includes a viewer identifier uid, a viewer name, a profile picture, a member rank, and the like.

The server may acquire, in the following manner, the current viewer information in the source channel corresponding to the source channel identifier. The server acquires, according to the source channel identifier, a viewer list of the source channel from the correspondence between the channel identifier and the viewer list, and acquires the current viewer information in the source channel from the viewer list of the source channel.

For example, if the server authenticates that the requester viewer corresponding to the requester viewer identifier uid has the right to initiate the scheduling request, the server acquires a channel “Girl's apartment” in which the requester viewer is currently located and uses it as a destination channel; and acquires, according to the source channel identifier ID1, a viewer list of a source channel “IM mobile phone technology seminar” from the correspondence between the channel identifier and the viewer list. It is assumed that the viewer list includes viewer information of a viewer 1 and viewer information of a viewer 2, and then the current viewer information, acquired from the viewer list of the source channel “IM mobile phone technology seminar” includes the viewer information of the viewer 1 and the viewer information of the viewer 2.

Step 204: Stop, according to the acquired current viewer information in the source channel, delivering content of the source channel to a current viewer in the source channel, and deliver content of a destination channel to viewers in the source channel.

The content of the destination channel is uploaded by a broadcaster corresponding to the destination channel and received by the server.

Further, the current viewer information (including an identifier, a name, a profile picture, a member rank, and the like) in the source channel is removed from the viewer list of the source channel; and the current viewer information in the source channel is stored into a viewer list of the destination channel in which the requester viewer is located in a schedulable manner; and a viewer list displayed in channel interfaces, of each viewer end in the destination channel, an administrator end and a channel broadcaster end that correspond to the destination channel are updated according to the viewer list of the destination channel.

For example, the server stops, according to viewer information of a viewer 1 and viewer information of a viewer 2 in the source channel, delivering content of the source channel to the viewer 1 and the viewer 2 in the source channel “IM mobile phone technology seminar”; delivers content of the destination channel “Girl's apartment” to the viewer 1 and the viewer 2. Further, the server removes the viewer information of the viewer 1 and the viewer information of the viewer 2 from the viewer list of the source channel “IM mobile phone technology seminar”; stores the viewer information of the viewer 1 and the viewer information of the viewer 2 into a viewer list of the destination channel “Girl's apartment” in a schedulable manner; and updates, according to the viewer list of the destination channel “Girl's apartment”, a viewer list displayed in channel interfaces, respectively in a viewer end corresponding to each viewer in the destination channel “Girl's apartment”, an administrator end and a channel broadcaster end that correspond to the destination channel “Girl's apartment”.

A difference between this embodiment and foregoing Embodiment 1 lies in that, in this embodiment, all viewers or some viewers in a source channel are scheduled to a sub-channel in which an administrator is currently located. Correspondingly, reference is made to FIG. 5 for a reference diagram of an interface displayed when an administrator end performs a scheduling request. It can be seen from FIG. 5 that, the administrator does not need to select a channel number of a destination channel when initiating the scheduling request, but only needs to click “Schedule to my channel in batch” to complete scheduling.

Persons skilled in the art may make improvement to the foregoing two implementation manners. For example, when an administrator makes settings for initiation of a schedule, a member rank of a scheduled viewer can be selected to set as a condition of being scheduled, and a viewer can be scheduled to a destination channel only when the viewer reaches a certain member rank.

### Embodiment 3

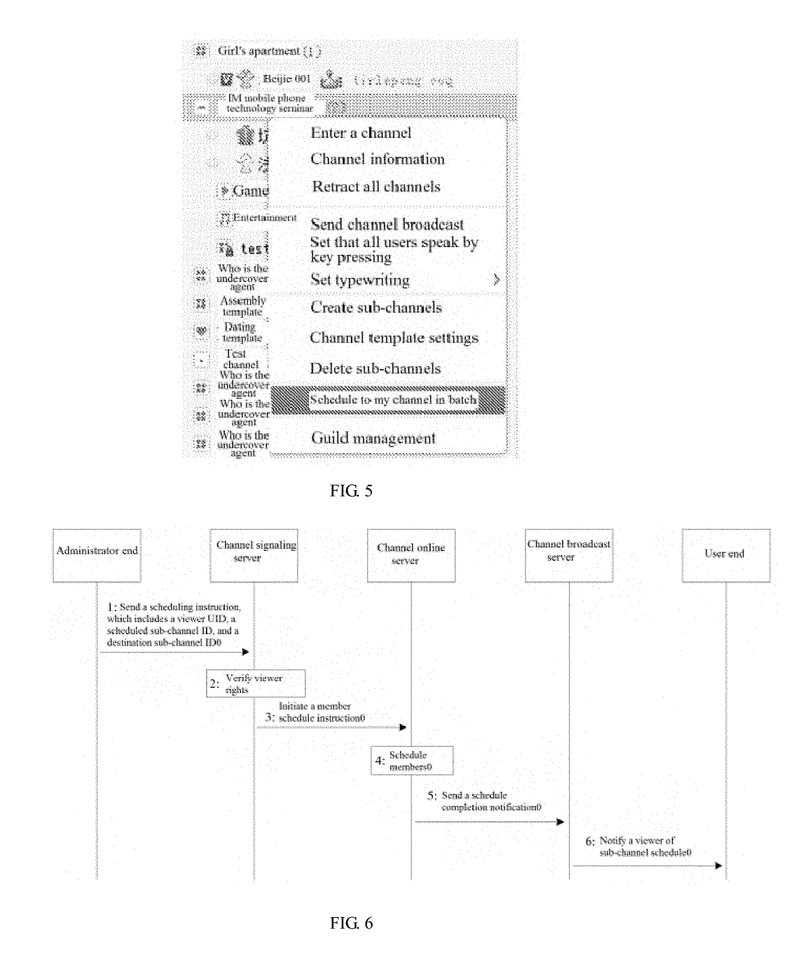

FIG. 6 is a time sequence diagram of an embodiment of the present invention, and referring to FIG. 6, a sequential process is described below.

1. An administrator end sends a scheduling instruction to a channel signaling server, where the scheduling instruction includes a viewer UID (a viewer identifier), a scheduled sub-channel ID (an identifier of a scheduled sub-channel), and a destination sub-channel ID0 (an identifier of a destination sub-channel).

2. The channel signaling server verifies whether a viewer corresponding to the viewer UID has a scheduling right.

3. The channel signaling server sends a member schedule instruction to a channel online server, where the member schedule instruction includes the scheduled sub-channel ID and the destination sub-channel ID0.

4. The channel online server receives the member schedule instruction, and switches viewers from the scheduled sub-channel corresponding to the scheduled sub-channel ID to the destination sub-channel corresponding to the destination sub-channel ID0.

5. The channel online server sends a schedule completion notification to a channel broadcast server, where the notification includes viewer information of each viewer in the scheduled sub-channel.

6. The channel broadcast server receives the schedule completion notification; and sends, according to the viewer information of each viewer which is included in the notification, a notification message to a viewer end corresponding to each viewer, where the notification message is used to notify the viewers of being switched to the destination sub-channel ID0.

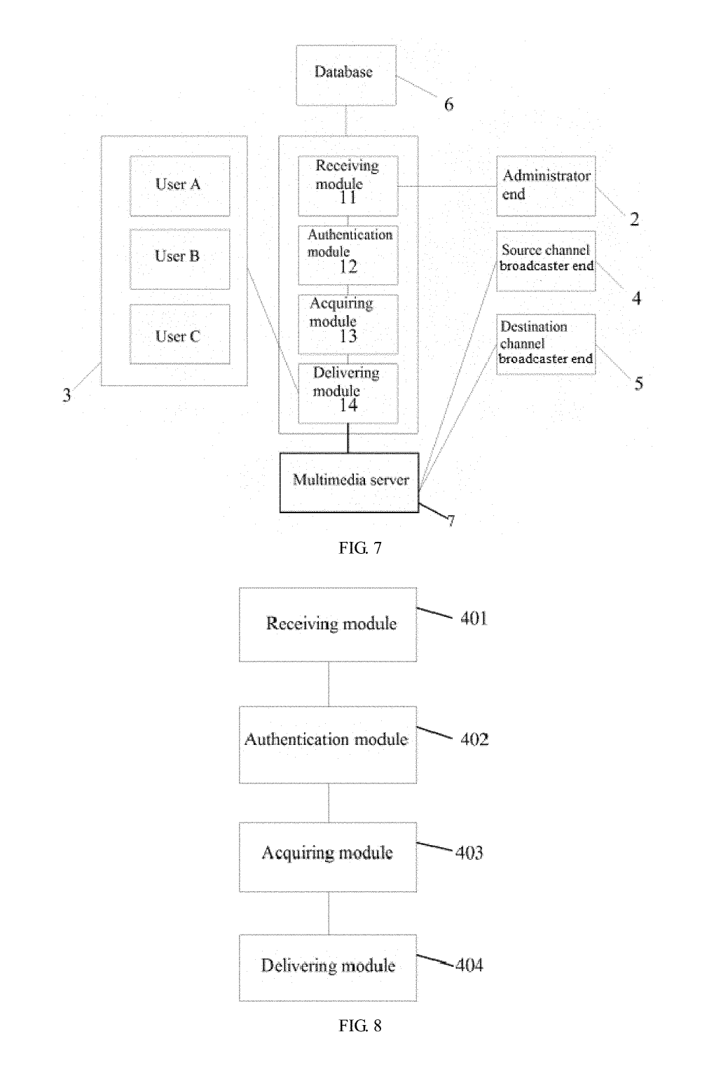

FIG. 7 is a block diagram of a platform system of above Embodiment 1 and Embodiment 2. The platform system includes a central processing server, a database 6, a multimedia server 7, an administrator end 2, and a channel broadcaster end (the channel broadcaster end may include a source channel broadcaster end 4 and a destination channel broadcaster end 5).

The central processing server in FIG. 7 includes a receiving module 11, an authentication module 12, an acquiring module 13, and a delivering module 14. The database 6 is configured to store viewer information of viewers, a correspondence list between each channel and one or more online viewer identifier number, a correspondence list between a UID (identifier) of each administrator and an ID of a channel managed by each administrator, and the like. The multimedia server 7 is configured to receive, process, and forward content uploaded by the channel broadcaster end. The viewer information of the viewers may be viewer personal information, the channel broadcaster end may be an broadcaster client, and the content uploaded by the channel broadcaster end may be multimedia audio/video content.

A certain main channel managed by the administrator has two sub-channels A and B, and has a management right for the sub-channels A and B. A specific operation is as follows:

1. The administrator end 2 sends a channel ID of the source channel A, a channel ID of the destination channel B, and a UID of the administrator end 2 to a server, and the receiving module 11 receives a scheduling request message initiated by the administrator end 2.

2. The authentication module 12 verifies whether the administrator UID has a management right for both the source channel and the destination channel.

3. If verification succeeds, the acquiring module 13 acquires, from the database 6, a UID of each viewer in a current viewer group 1 in the source channel and other viewer information, where other viewer information may be, for example, a member rank and a nickname.

4. The delivering module 14 delivers, according to the UID of each viewer, a notification message carrying the destination channel ID, so as to notify the viewer group 1 of being switched to the destination channel; the viewer sends a channel entering request carrying the destination channel ID to the signaling server; and the signaling server forwards the channel entering request carrying the destination channel ID and the viewer UID to the multimedia server 7.

The delivering module 14 stops, according to the acquired current viewer UID in the source channel, delivering multimedia content of the source channel to the current viewer in the source channel; and pulls multimedia content of the destination channel from the multimedia server 7 and delivers the multimedia content to the viewer group 1. The delivering module delivers viewer information, such as a member rank and a nickname, in the viewer group 1 to each viewer client; and the client updates information displayed in a channel viewer list, such as the viewer nickname and the member rank.

The beneficial effects of the technical solutions of the foregoing embodiment of the present invention are as follows:

1. It is convenient for an administrator to schedule, in channels for which the administrator has a management and scheduling right, members in the channels managed by the administrator.

2. A confirmation is not need byMembers in a group of a source channel, and therefore real-time capacity of scheduling is greatly improved.

3. An operation security permission of an invoker to the source channel and the destination channel is ensured meanwhile a invoke for a group is facilitated.

4. A group administrator gives a convenient guide to a group managed by the group administrator.

### Embodiment 4

Referring to FIG. 8, this embodiment of the present invention provides a system for scheduling viewers between channels in real time, which includes:

a receiving module 401, configured to receive a scheduling request message initiated by a scheduling request initiation end, where the scheduling request message includes a requester viewer identifier, a source channel identifier, and a destination channel identifier;

an authentication module 402, configured to authenticate whether a requester viewer corresponding to the requester viewer identifier has the right to initiate a scheduling request;

an acquiring module 403, configured to acquire, if it is authenticated that the requester viewer has the right to initiate the scheduling request, current viewer information in a source channel corresponding to the source channel identifier and content of a destination channel corresponding to the destination channel identifier; and

a delivering module 404, configured to stop, according to the current viewer information in the source channel, delivering content of the source channel to a current viewer in the source channel, and deliver content of a destination channel to the current viewer in the source channel.

The acquired current viewer information in the source channel corresponding to the source channel identifier includes, but is not limited to, a viewer identifier, a viewer name, a profile picture, and a member rank.

Further, the system further includes:

a removing and scheduling module, configured to remove the current viewer information in the source channel from a viewer list of the source channel, display the current viewer information from the source channel in a viewer list of the destination channel in a schedulable manner.

Further, the system further includes:

updating, according to the viewer list of the destination channel, a viewer list displayed in channel interfaces respectively in a viewer end of each viewer in the destination channel, an administrator end and an broadcaster end that correspond to the destination channel.

The source channel and the destination channel are two sub-channels belonging to the same parent channel.

Optionally, the authentication module 402 is configured to match the requester viewer identifier with a preset specific viewer identifier; and if they match, authenticate that the requester viewer corresponding to the requester viewer identifier has the right to initiate the scheduling request, where the preset specific viewer identifier includes an identifier of an administrator or a creator for the source channel and the destination channel.

In the technical solutions of this embodiment, information about all viewers in a source channel is automatically acquired, and all the viewers are scheduled from the source channel to a destination channel, thereby achieving real-time scheduling of viewers between channels. Such a manner avoids complicated steps of initiating requests/invitations one by one, then approving one by one, and scheduling one by one in the prior art, and can rapidly achieve scheduling of a large number of group viewers in a channel and greatly improve work efficiency of scheduling group viewers.

### Embodiment 5

Referring to FIG. 8, this embodiment of the present invention provides a system for scheduling viewers between channels in real time, which includes:

a receiving module 401, configured to receive a scheduling request message, where the scheduling request message includes a requester viewer identifier and a source channel identifier;

an authentication module 402, configured to authenticate whether a requester viewer corresponding to the requester viewer identifier has the right to initiate a scheduling request;

an acquiring module 403, configured to acquire, if it is authenticated that the requester viewer has the right to initiate the scheduling request, current viewer information in a source channel corresponding to the source channel identifier and content of a channel in which the requester viewer is currently located; and

a delivering module 404, configured to stop, according to the current viewer information in the source channel, delivering content of the source channel to a current viewer in the source channel, and deliver content of the channel, in which the requester viewer is located, to viewers in the source channel.

The acquired current viewer information in the source channel corresponding to the source channel identifier includes, but is not limited to, a viewer identifier, a viewer name, a profile picture, and a member rank.

Further, the system further includes:

a removing and scheduling module, configured to remove the current viewer information in the source channel from a viewer list of the source channel, schedule the current viewer information from the source channel to a viewer list of the destination channel and display it in the viewer list of the destination channel.

Further, the system further includes:

updating, according to the viewer list of the destination channel, a viewer list displayed in channel interfaces respectively in a viewer end of each viewer in the destination channel, an administrator end and an broadcaster end that correspond to the destination channel.

### Embodiment 6

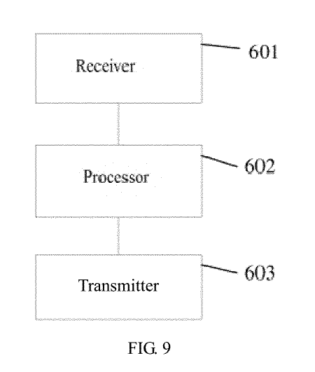

Referring to FIG. 9, this embodiment of the present invention provides a server, which includes a receiver 601, a processor 602, and a transmitter 603.

The receiver 601 is configured to receive a scheduling request message, where the scheduling request message includes a requester viewer identifier, a source channel identifier, and a destination channel identifier.

The processor 602 is configured to authenticate whether a requester viewer corresponding to the requester viewer identifier has the right to initiate a scheduling request; acquire current viewer information in a source channel corresponding to the source channel identifier when it is authenticated that the requester viewer has the right to initiate the scheduling request; remove the current viewer information in the source channel from a viewer list of the source channel, and add the current viewer information in the source channel to a viewer list of a destination channel corresponding to the destination channel identifier.

The transmitter 603 is configured to deliver content of the destination channel to viewers in the viewer list of the destination channel.

The acquired current viewer information in the source channel corresponding to the source channel identifier includes, but is not limited to, a viewer identifier, a viewer name, a profile picture, and a member rank.

Further, the processor 602 is further configured to update, according to the viewer list of the destination channel, a viewer list displayed in channel interfaces, respectively in a viewer end of each viewer in the destination channel, an administrator end and an broadcaster end that correspond to the destination channel.

The source channel and the destination channel are two sub-channels belonging to the same parent channel.

Optionally, an operation, executed by the processor 602, of authenticating whether a requester viewer corresponding to the requester viewer identifier has the right to initiate a scheduling request may be:

matching the requester viewer identifier with a preset specific viewer identifier; and if they match, authenticating that the requester viewer corresponding to the requester viewer identifier has the right to initiate the scheduling request, where the preset specific viewer identifier includes an identifier of an administrator or a creator for the source channel and the destination channel.

### Embodiment 7

Referring to FIG. 9, this embodiment of the present invention provides a server, which includes a receiver 601, a processor 602, and a transmitter 603.

The receiver 601 is configured to receive a scheduling request message, where the scheduling request message includes a requester viewer identifier and a source channel identifier.

The processor 602 is configured to authenticate whether a requester viewer corresponding to the requester viewer identifier has the right to initiate a scheduling request; acquire, if it is authenticated that the requester viewer has the right to initiate the scheduling request, a channel in which the requester viewer is currently located and use the channel as a destination channel; and acquire current viewer information in a source channel corresponding to the source channel identifier.

The transmitter 603 is configured to deliver content of the destination channel to viewers in the source channel according to the current viewer information in the source channel.

The acquired current viewer information in the source channel corresponding to the source channel identifier includes, but is not limited to, a viewer identifier, a viewer name, a profile picture, and a member rank.

Further, the processor 602 is further configured to remove the current viewer information in the source channel from a viewer list of the source channel, display the current viewer information from the source channel in a viewer list of the destination channel in a schedulable manner.

Further, the processor 602 is further configured to update, according to the viewer list of the destination channel, a viewer list displayed in channel interfaces respectively in a viewer end of each viewer in the destination channel, an administrator end and an broadcaster end that correspond to the destination channel.

Based on the foregoing descriptions of the disclosed embodiments, persons skilled in the art can implement or use the invention patent. Various modifications made to these embodiments will be apparent to those skilled in the art, and the generic principles defined herein may be implemented in other embodiments without departing from the spirit or scope of the invention patent. Accordingly, the invention patent is not limited to the embodiments shown herein but should accord with the widest scope consistent with the principles disclosed herein and novelly created features.

1. A method for scheduling viewers between channels, comprising:
receiving a scheduling request message, wherein the scheduling request message comprises a requester viewer identifier, a source channel identifier, and a destination channel identifier;
authenticating whether a requester viewer corresponding to the requester viewer identifier has the right to initiate a scheduling request;
acquiring current viewer information in a source channel corresponding to the source channel identifier when it is authenticated that the requester viewer has the right to initiate the scheduling request;
removing the current viewer information in the source channel from a viewer list of the source channel, and adding the current viewer information in the source channel to a viewer list of a destination channel corresponding to the destination channel identifier; and
delivering content of the destination channel to viewers in the viewer list of the destination channel.

2. The method according to claim 1, wherein
the acquired current viewer information in the source channel corresponding to the source channel identifier comprises, but is not limited to, a viewer identifier, a viewer name, a profile picture, and a member rank.

3. The method according to claim 1, further comprising:
updating, according to the viewer list of the destination channel, a viewer list displayed in channel interfaces respectively in a viewer end of each viewer in the destination channel, an administrator end and an broadcaster end that correspond to the destination channel.

4. The method according to claim 1, wherein the source channel and the destination channel are sub-channels belonging to the same parent channel.

5. The method according to claim 1, wherein the authenticating whether the requester viewer corresponding to the requester viewer identifier has the right to initiate the scheduling request specifically comprises:
matching the requester viewer identifier with a preset specific viewer identifier; and authenticating that the requester viewer corresponding to the requester viewer identifier has the right to initiate the scheduling request when they match, wherein the preset specific viewer identifier comprises an identifier of an administrator or a creator for the source channel and the destination channel.

6. A method for scheduling viewers between channels, comprising:
receiving a scheduling request message, wherein the scheduling request message comprises a requester viewer identifier and a source channel identifier;
authenticating whether a requester viewer corresponding to the requester viewer identifier has the right to initiate a scheduling request;
acquiring a channel in which the requester viewer is currently located, and using the channel as a destination channel when it is authenticated that the requester viewer has the right to initiate the scheduling request;
acquiring current viewer information in a source channel corresponding to the source channel identifier; and
delivering content of the destination channel to viewers in the source channel according to the current viewer information in the source channel.

7. The method according to claim 6, wherein the acquired current viewer information in the source channel corresponding to the source channel identifier comprises, but is not limited to, a viewer identifier, a viewer name, a profile picture, and a member rank.

8. The method according to claim 6, further comprising:
removing the current viewer information in the source channel from a viewer list of the source channel, and displaying the current viewer information of the source channel in a viewer list of the destination channel in a schedulable manner; and
updating, according to the viewer list of the destination channel, a viewer list displayed in channel interfaces respectively in a viewer end of each viewer in the destination channel, an administrator end and an broadcaster end that correspond to the destination channel.

9. A method for scheduling viewers between channels, comprising:
initiating a scheduling request message at a source channel, wherein the scheduling request message comprises a requester viewer identifier, a source channel identifier, and a destination channel identifier;
displaying current viewer information from the source channel corresponding to the source channel identifier in a viewer list of a destination channel corresponding to the destination channel identifier in a schedulable manner;
receiving content of the destination channel; and
delivering the content of the destination channel to viewers of the source channel according to the current viewer information in the source channel.

10. (canceled)

11. (canceled)

12. (canceled)

13. (canceled)

14. (canceled)

15. The method according to claim 2, further comprising:
updating, according to the viewer list of the destination channel, a viewer list displayed in channel interfaces respectively in a viewer end of each viewer in the destination channel, an administrator end and an broadcaster end that correspond to the destination channel.

16. The method according to claim 15, wherein the source channel and the destination channel are sub-channels belonging to the same parent channel.

17. The method according to claim 16, wherein the authenticating whether the requester viewer corresponding to the requester viewer identifier has the right to initiate the scheduling request specifically comprises:
matching the requester viewer identifier with a preset specific viewer identifier; and authenticating that the requester viewer corresponding to the requester viewer identifier has the right to initiate the scheduling request when they match, wherein the preset specific viewer identifier comprises an identifier of an administrator or a creator for the source channel and the destination channel.

18. The method according to claim 7, further comprising:
removing the current viewer information in the source channel from a viewer list of the source channel, and displaying the current viewer information of the source channel in a viewer list of the destination channel in a schedulable manner; and
updating, according to the viewer list of the destination channel, a viewer list displayed in channel interfaces respectively in a viewer end of each viewer in the destination channel, an administrator end and an broadcaster end that correspond to the destination channel.

19. The method according to claim 3, wherein the source channel and the destination channel are sub-channels belonging to the same parent channel.

20. The method according to claim 19, wherein the authenticating whether the requester viewer corresponding to the requester viewer identifier has the right to initiate the scheduling request specifically comprises:
matching the requester viewer identifier with a preset specific viewer identifier; and authenticating that the requester viewer corresponding to the requester viewer identifier has the right to initiate the scheduling request when they match, wherein the preset specific viewer identifier comprises an identifier of an administrator or a creator for the source channel and the destination channel.
